(19) United States
(12) Patent Application Publication
(10) Pub. No.: US 2005/0022636 A1
(43) Pub. Date: Feb. 3, 2005

(54) Screw member

(76) Inventor: Chih-Ching Hsien, Taichung (TW)

Correspondence Address: Chih-Ching Hsien, 58, MA YUAN WEST ST., TAICHUNG, TW

(21) Appl. No.: 10/634,184

(22) Filed: Jul. 30, 2003

(51) Int. Cl. B25B 23/00

(52) U.S. Cl. 81/460

(57) ABSTRACT

A screw member includes a main body having a first end provided with a head portion and a second end provided with a threaded portion. The head portion has a center formed with a substantially Y-shaped insertion recess including three locking grooves. The three locking grooves of the insertion recess of the head portion are equally divided portions of the circular head portion, so that the tip of the screwdriver is combined with the head portion in a co-planar three-point contact manner. Thus, the screw member is combined with the screwdriver rigidly and stably.

### BACKGROUND OF THE INVENTION

1. Field of the Invention

The present invention relates to a screw member, and more particularly to a screw member that is combined with a screwdriver in a co-planar three-point contact manner, so that the screw member is combined with the screwdriver rigidly and stably.

2. Description of the Related Art

FIG. 5 shows a conventional screw member 30 having a linear slot 32. FIG. 6 shows another conventional screw member 40 having a cross-shaped slot 42. FIG. 7 shows another conventional screw member 30A having a linear slot 32A. FIG. 8 shows another conventional screw member 40A having a cross-shaped slot 42A. FIG. 9 shows a conventional screwdriver 50 having a linear tip 52 that can be inserted into the linear slot 32 as shown in FIG. 5 or the linear slot 32A as shown in FIG. 7. FIG. 10 shows another conventional screwdriver 60 having a cross-shaped tip 62 that can be inserted into the cross-shaped slot 42 as shown in FIG. 6 or the cross-shaped slot 42A as shown in FIG. 8.

As shown in FIGS. 11 and 12, the linear tip 52 of the screwdriver 50 has two points A and B in contact with the linear slot 32 of the screw member 30. When the linear tip 52 of the screwdriver 50 is rotated, the forces F2 and F1 applied by the screw member 30 are supported by the two points A and B of the linear tip 52 of the screwdriver 50, so that the user has to exert a larger force to rotate the screw member 30, thereby wasting the user's energy.

As shown in FIGS. 13 and 14, the cross-shaped tip 62 of the screwdriver 60 has four points C, D, E and F in contact with the cross-shaped slot 42 of the screw member 40. When the cross-shaped tip 62 of the screwdriver 60 is rotated, the forces F1, F3, F2 and F4 applied by the screw member 40 are supported by the four points C, D, E and F of the cross-shaped tip 62 of the screwdriver 60. However, the cross-shaped slot 42 of the screw member 40 weakens the strength of the screw member 40, so that of the screw member 40 is easily worn out during a long-term utilization.

### SUMMARY OF THE INVENTION

The primary objective of the present invention is to provide a screw member that is combined with a screwdriver in a co-planar three-point contact manner, so that the screw member is combined with the screwdriver rigidly and stably.

Another objective of the present invention is to provide a screw member, wherein the three locking grooves of the insertion recess of the head portion are equally divided portions of the circular head portion, so that the tip of the screwdriver is combined with the head portion in a co-planar three-point contact manner.

A further objective of the present invention is to provide a screw member, wherein the three locking grooves of the insertion recess of the head portion have the same cross-sectional area, so that the force applied on the head portion is evenly distributed on the three locking grooves of the insertion recess of the head portion. Thus, the head portion of the screw member has a reinforced strength and can withstand a larger torque.

A further objective of the present invention is to provide a screw member, wherein the tip of the screwdriver is combined with the head portion in a co-planar three-point contact manner, so that the tangential directions of the forces applied on the tip of the screwdriver form a substantially circular curve which aligns with the circular rotation direction of the tip of the screwdriver. Thus, the head portion of the screw member can be rotated by the tip of the screwdriver easily and conveniently.

In accordance with the present invention, there is provided a screw member, comprising a main body having a first end provided with a head portion, wherein:

the head portion has a center formed with a substantially Y-shaped insertion recess.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a screwdriver in accordance with the preferred embodiment of the present invention;

FIG. 2 is a perspective view of a screw member in accordance with the preferred embodiment of the present invention;

FIG. 3 is a top plan cross-sectional assembly view of the screw member and the screwdriver as shown in FIGS. 1 and 2;

FIG. 4 is a partially cut-away plan assembly view of the screw member and the screwdriver as shown in FIGS. 1 and 2;

FIG. 5 is a perspective view of a conventional screw member in accordance with the prior art;

FIG. 6 is a perspective view of another conventional screw member in accordance with the prior art;

FIG. 7 is a perspective view of another conventional screw member in accordance with the prior art;

FIG. 8 is a perspective view of another conventional screw member in accordance with the prior art;

FIG. 9 is a perspective view of a conventional screwdriver in accordance with the prior art;

FIG. 10 is a perspective view of another conventional screwdriver in accordance with the prior art;

FIG. 11 is a partially cut-away plan assembly view of the conventional screw member and the conventional screwdriver as shown in FIGS. 5 and 9;

FIG. 12 is a top plan cross-sectional assembly view of the conventional screw member and the conventional screwdriver as shown in FIGS. 5 and 9;

FIG. 13 is a partially cut-away plan assembly view of the conventional screw member and the conventional screwdriver as shown in FIGS. 6 and 10; and

FIG. 14 is a top plan cross-sectional assembly view of the conventional screw member and the conventional screwdriver as shown in FIGS. 6 and 10.

### DETAILED DESCRIPTION OF THE INVENTION

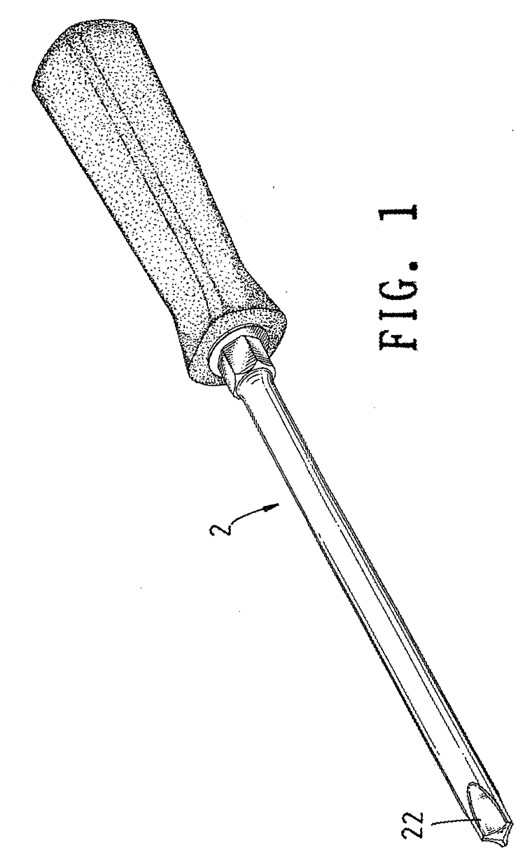

Referring to the drawings and initially to FIGS. 1-3, a screw member (see FIG. 2) in accordance with the preferred embodiment of the present invention can be operated by a screwdriver 2 (see FIG. 1). The screw member comprises a main body 1 having a first end provided with a head portion 11 and a second end provided with a threaded portion 12. The head portion 11 has a planar and circular shape. In addition, the head portion 11 has a center formed with a substantially Y-shaped insertion recess 111. The insertion recess 111 of the head portion 11 includes three locking grooves 1110. Preferably, the three locking grooves 1110 of the insertion recess 111 of the head portion 11 are equally divided portions of the circular head portion 11. The screwdriver 2 has a substantially Y-shaped tip 22.

In operation, when the tip 22 of the screwdriver 2 is inserted into the insertion recess 111 of the head portion 11, the tip 22 of the screwdriver 2 is locked in the three locking grooves 1110 of the insertion recess 111 of the head portion 11, so that the tip 22 of the screwdriver 2 is combined with the insertion recess 111 of the head portion 11 in a co-planar three-point contact manner. Thus, the tip 22 of the screwdriver 2 is combined with the head portion 11 of the screw member rigidly and stably.

In addition, each of the three locking grooves 1110 of the insertion recess 111 of the head portion 11 has a wall having the same cross-sectional area, so that the force applied on the head portion 11 is evenly distributed on the three locking grooves 1110 of the insertion recess 111 of the head portion 11. Thus, the head portion 11 of the screw member has a reinforced strength and can withstand a larger torque.

Accordingly, the screw member in accordance with the preferred embodiment of the present invention has the following advantages.

1. The three locking grooves 1110 of the insertion recess 111 of the head portion 11 are equally divided portions of the circular head portion 11, so that the tip 22 of the screwdriver 2 is combined with the head portion 11 in a co-planar three-point contact manner. Thus, the tip 22 of the screwdriver 2 is combined with the head portion 11 of the screw member rigidly and stably.

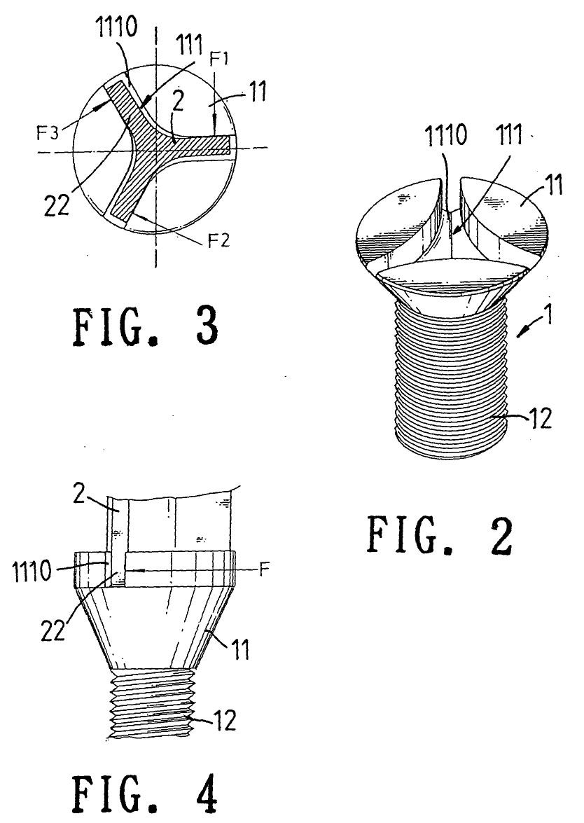

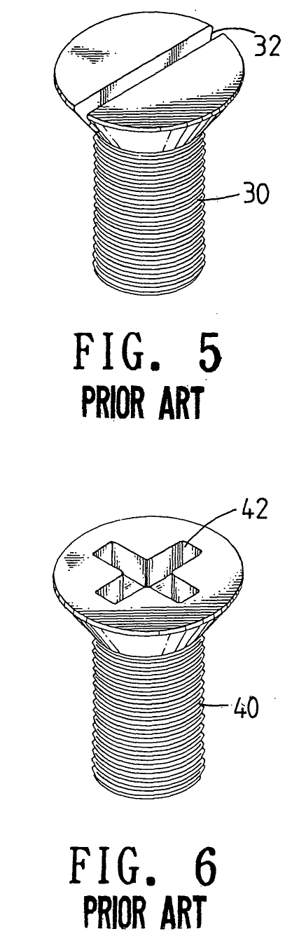

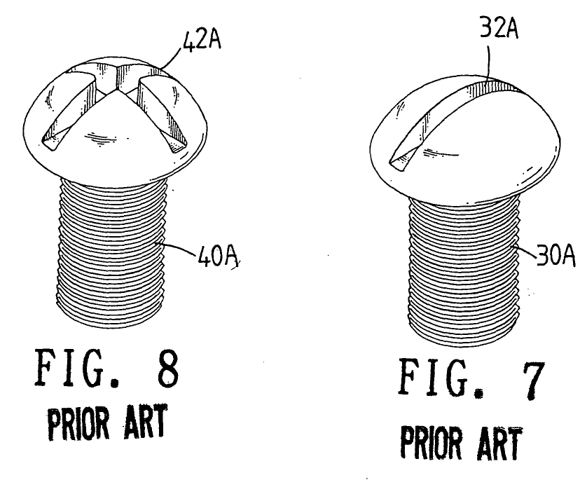

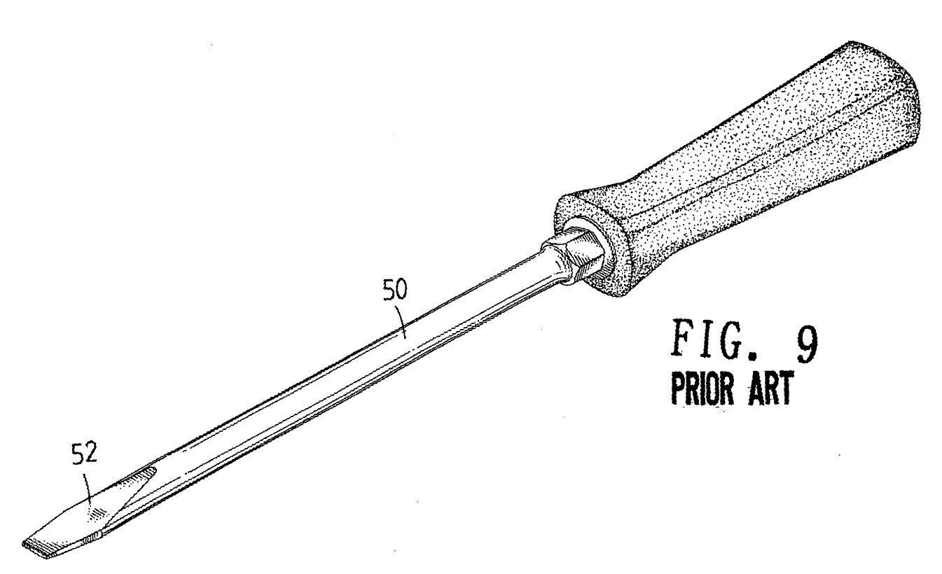

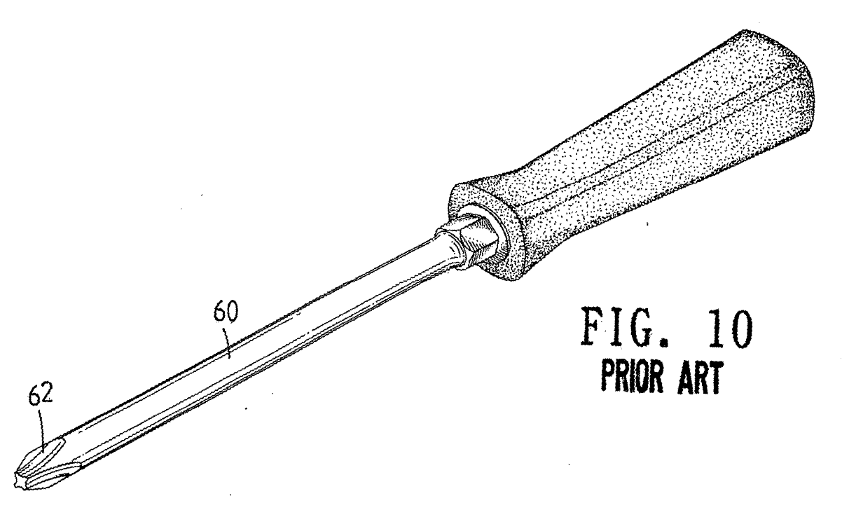

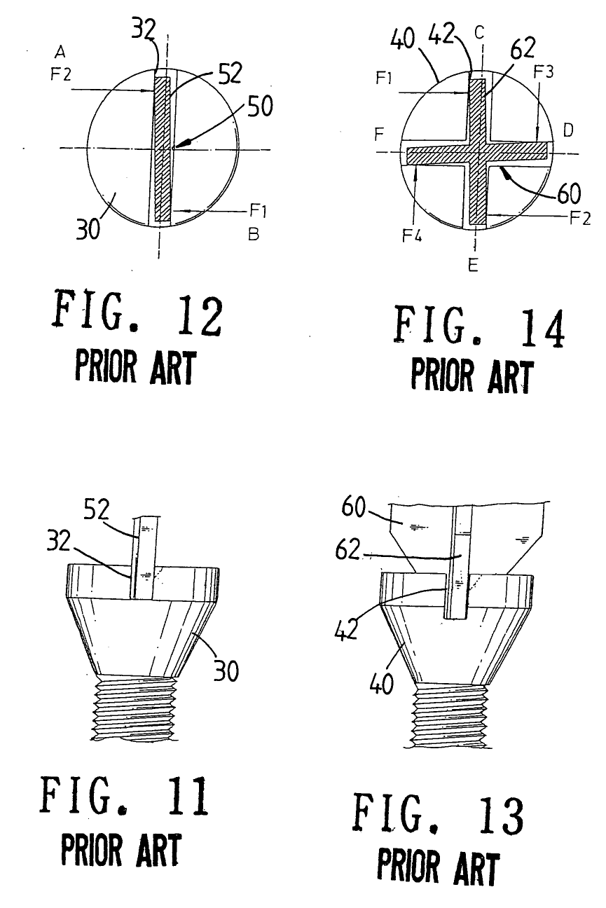

2. The three locking grooves 1110 of the insertion recess 111 of the head portion 11 have the same cross-sectional area, so that the force F (see FIG. 4) applied on the head portion 11 is evenly distributed on the three locking grooves 1110 of the insertion recess 111 of the head portion 11. Thus, the head portion 11 of the screw member has a reinforced strength and can withstand a larger torque.

3. The tip 22 of the screwdriver 2 is combined with the head portion 11 in a co-planar three-point contact manner, so that the tangential directions of the forces F1, F2 and F3 (see FIG. 3) applied by the three locking grooves 1110 of the insertion recess 111 of the head portion 11 on the tip 22 of the screwdriver 2 form a substantially circular curve which aligns with the circular rotation direction of the tip 22 of the screwdriver 2. Thus, the head portion 11 of the screw member can be rotated by the tip 22 of the screwdriver 2 easily and conveniently.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A screw member, comprising a main body having a first end provided with a head portion, wherein:
the head portion has a center formed with a substantially Y-shaped insertion recess.

2. The screw member in accordance with claim 1, wherein the head portion has a planar shape.

3. The screw member in accordance with claim 1, wherein the head portion has a circular shape.

4. The screw member in accordance with claim 1, wherein the insertion recess of the head portion includes three locking grooves.

5. The screw member in accordance with claim 4, wherein the head portion has a circular shape, and the three locking grooves of the insertion recess of the head portion are equally divided portions of the circular head portion.

6. The screw member in accordance with claim 4, further comprising a screwdriver having a substantially Y-shaped tip inserted into the insertion recess of the head portion and locked in the three locking grooves of the insertion recess of the head portion.

7. The screw member in accordance with claim 6, wherein the tip of the screwdriver is combined with the insertion recess of the head portion in a co-planar three-point contact manner.

8. The screw member in accordance with claim 7, wherein the tip of the screwdriver is combined with the head portion in a co-planar three-point contact manner, so that the tangential directions of three forces applied by the three locking grooves of the insertion recess of the head portion on the tip of the screwdriver form a substantially circular curve which aligns with the circular rotation direction of the tip of the screwdriver.

9. The screw member in accordance with claim 4, wherein each of the three locking grooves of the insertion recess of the head portion has a wall having the same cross-sectional area.

10. The screw member in accordance with claim 1, wherein the main body has a second end provided with a threaded portion.
